(19) United States
(12) Patent Application Publication
(10) Pub. No.: US 2020/0280226 A1
(43) Pub. Date: Sep. 3, 2020

(54) ROTOR OF ROTARY ELECTRIC MACHINE

(71) Applicant: HONDA MOTOR CO., LTD., Tokyo (JP)

(72) Inventor: Yusuke OCHIAI, Saitama (JP)

(73) Assignee: HONDA MOTOR CO., LTD., Tokyo (JP)

(21) Appl. No.: 16/801,960

(22) Filed: Feb. 26, 2020

(30) Foreign Application Priority Data
Mar. 1, 2019 (JP) 2019-037601

(51) Int. Cl. H02K 1/27; H02K 9/19; H02K 1/32

(52) U.S. Cl. CPC H02K 1/276; H02K 1/32; H02K 9/19

(57) ABSTRACT

A rotor of a rotary electric machine includes: a rotor core; a plurality of magnets; and a rotor shaft. The rotor core includes: a plurality of magnet attaching grooves formed on the outer peripheral surface of the rotor core and in which the magnets are disposed; an in-core flow path extending inside the rotor core in an axial direction of the rotor core; and a refrigerant distribution plate. The refrigerant distribution plate includes: a first refrigerant distribution plate in which an inner-diameter-side refrigerant flow path extending from an in-shaft flow path toward the in-core flow path as viewed from the axial direction is formed; and a second refrigerant distribution plate in which an outer-diameter-side refrigerant flow path extending from the in-core flow path toward the magnet attaching groove as viewed from the axial direction is formed. The first refrigerant distribution plate and the second refrigerant distribution plate are stacked in the axial direction.

### CROSS-REFERENCE TO RELATED APPLICATIONS

The present application claims the benefit of priority of Japanese Patent Application No. 2019-037601, filed on Mar. 1, 2019, the content of which is incorporated herein by reference.

### TECHNICAL FIELD

The present invention relates to a rotor of a rotary electric machine mounted on an electric vehicle or the like.

### BACKGROUND ART

In recent years, rotary electric machines have been used in hybrid vehicles and EV vehicles. When a rotary electric machine rotates, the temperature of a magnet increases, which greatly affects the performance of the rotary electric machine. Therefore, proper cooling is required.

JP-A-2017-070148 describes that, in an Interior Permanent Magnet Motor (IPM motor), a first plate having a first refrigerant passage and a second plate having a second refrigerant passage are stacked one by one to form a refrigerant distribution plate.

The rotary electric machine described in JP-A-2017-070148 is an IPM motor, so it cannot be directly applied to a Surface Permanent Magnet Motor (SPM motor) having a magnet fixed to the outer peripheral surface of a rotor.

Further, in the rotary electric machine of JP-A-2017-070148, a refrigerant passes through a vicinity of the magnet and is discharged to the outer peripheral side, there is a possibility that the magnet cannot be cooled appropriately.

### SUMMARY

The invention provides a rotor of a rotary electric machine which can appropriately cool a magnet disposed on an outer peripheral surface of a rotor core.

According to an aspect of the invention, there is provided a rotor of a rotary electric machine including: a rotor core; a plurality of magnets arranged on an outer peripheral surface of the rotor core; and a rotor shaft rotating integrally with the rotor core, wherein: the rotor shaft includes an in-shaft flow path through which a refrigerant is supplied; the rotor core includes: a plurality of magnet attaching grooves formed on the outer peripheral surface of the rotor core and in which the magnets are disposed; an in-core flow path extending inside the rotor core in an axial direction of the rotor core; and a refrigerant distribution plate; the refrigerant distribution plate includes: a first refrigerant distribution plate in which an inner-diameter-side refrigerant flow path extending from the in-shaft flow path toward the in-core flow path as viewed from the axial direction is formed; and a second refrigerant distribution plate in which an outer-diameter-side refrigerant flow path extending from the in-core flow path toward the magnet attaching groove as viewed from the axial direction is formed; and the first refrigerant distribution plate and the second refrigerant distribution plate are stacked in the axial direction.

According to the invention, the magnet can be cooled from the inside of the rotor core by the refrigerant supplied to an in-rotor-core flow path and the magnet can be directly cooled by the refrigerant supplied to the magnet attaching groove, so that the magnet can be appropriately cooled.

### BRIEF DESCRIPTION OF THE DRAWINGS

FIG. 1 is a perspective view of a rotor of a rotary electric machine according to an embodiment of the invention;

FIG. 2 is an exploded perspective view of a rotor core of the rotary electric machine in FIG. 1;

FIG. 3 is a perspective view of a refrigerant distribution plate of the rotor of the rotary electric machine in FIG. 1;

FIG. 4 is an exploded perspective view in which a part of the refrigerant distribution plate is exploded to explain an outer diameter side refrigerant flow path:

FIG. 5 is an enlarged view of a part of the refrigerant distribution plate:

FIG. 6 is a view of a first refrigerant distribution plate as viewed from an axial direction; and

FIG. 7 is a view of a second refrigerant distribution plate as viewed from the axial direction.

### DESCRIPTION OF EMBODIMENTS

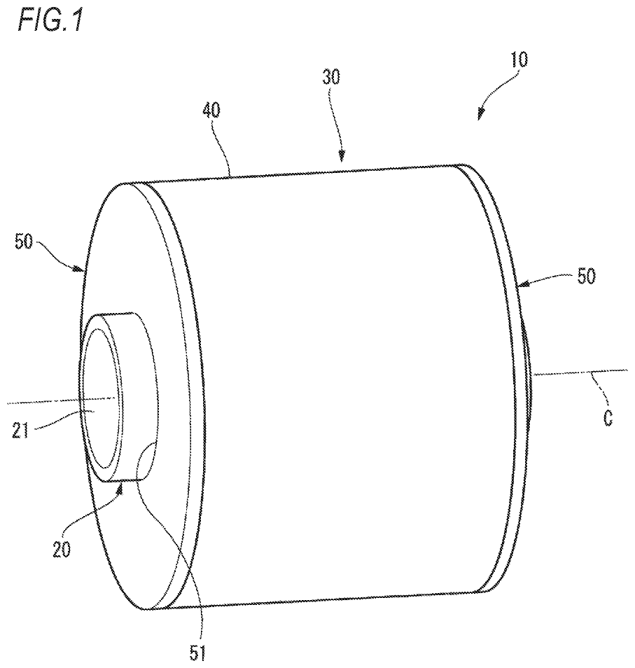

An embodiment of a rotor of a rotary electric machine according to the invention will be described below with reference to FIGS. 1 to 7.

In the following description, the term “rotation axis C” refers to a central axis when a rotor 10 or a rotor shaft 20 of the rotary electric machine rotates and an axial direction refers to a direction along the rotation axis C. In addition, the term “circumferential direction” refers to a direction along a circumference of a circle drawn around a point in a state where the rotation axis C is seen as the point. Further, the term “radial direction” refers to a direction from the point to the circle or a direction from the circle to the point. The term “radially outward” means a direction from the point toward the circle. The term “radially inward” means a direction from the circle toward the point.

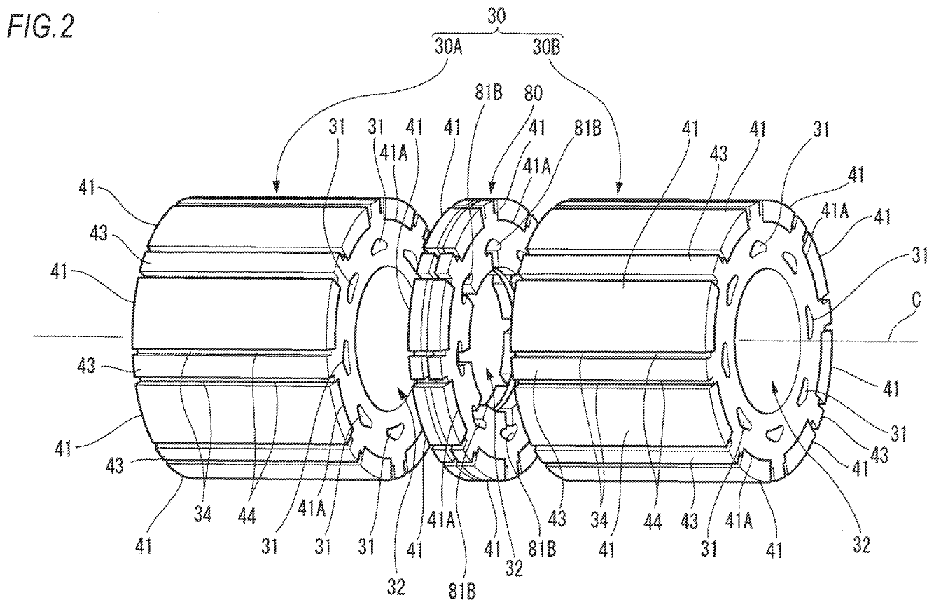

As illustrated in FIGS. 1 and 2, the rotor 10 of the rotary electric machine according to the embodiment includes the rotor shaft 20, a rotor core 30 supported by the rotor shaft 20, a refrigerant distribution plate 80 interposed in the rotor core 30, and a pair of end plates 50 arranged in the axial direction of the rotor core 30.

The rotor 10 of the rotary electric machine is a so-called SPM-type rotary electric machine in which magnets 41 are arranged on a surface of the rotor core 30. The magnets 41 are arranged in a magnet attaching groove 41A provided on the outer peripheral surface of the rotor core 30 and the magnet attaching groove 41A provided on the outer peripheral surface of the refrigerant distribution plate 80. The outer diameter of the rotor core 30 on which the magnet 41 is disposed is set to be substantially the same as the outer diameter of the refrigerant distribution plate 80 on which the magnet 41 is disposed. A sleeve 40 of a cylindrical shape is provided on the outer peripheral surfaces of the rotor core 30 and the refrigerant distribution plate 80 to prevent the magnets 41 from coming off the magnet attaching grooves 41A. The outer diameter means a distance from the rotation axis C.

Inside the rotor shaft 20, an in-shaft flow path 21 through which the refrigerant flows is formed. The in-shaft flow path 21 extends in the axial direction inside the rotor shaft 20 and is configured so that the refrigerant can be supplied from the outside. As the refrigerant, for example, Automatic Transmission Fluid (ATF) is used and a circulation path is formed so that the ATF circulates between a transmission case and a motor housing.

On the rotor shaft 20, one or more refrigerant supply portions (not illustrated) for sending the refrigerant from the in-shaft flow path 21 to the rotor core 30 side are formed in communication with the in-shaft flow path 21.

The rotor core 30 is configured by stacking a plurality of electromagnetic steel sheets. As illustrated in FIG. 2, the rotor core 30 includes a first rotor core 30A and a second rotor core 30B. The first rotor core 30A and the second rotor core 30B are arranged so as to face each other across the refrigerant distribution plate 80 in the axial direction. In the embodiment, the refrigerant distribution plate 80 is disposed substantially at the center of the rotor core 30 in the axial direction.

The refrigerant distribution plate 80 may be disposed on one side in the axial direction with respect to the first rotor core 30A and the second rotor core 30B. However, by arranging the refrigerant distribution plate 80 approximately at the center of the first rotor core 30A and the second rotor core 30B in the axial direction, the temperature distribution of the magnets 41 in the axial direction can be suppressed as compared with a case where the refrigerant distribution plate 80 is arranged on one side of the first rotor core 30A and the second rotor core 30B.

A shaft insertion hole 32 is formed in the center of the rotor core 30 and the refrigerant distribution plate 80, penetrating in the axial direction and into which the rotor shaft 20 is inserted. It is preferable that the electromagnetic steel sheets constituting the rotor core 30 have the same shape and that the respective sheet thicknesses (lengths in the axial direction) be set to substantially the same sheet thickness. The rotor shaft 20 is inserted into the shaft insertion holes 32 of the rotor core 30 and the refrigerant distribution plate 80 and the shaft insertion holes 51 of the pair of end plates 50, so the rotor shaft 20, the rotor core 30, the refrigerant distribution plate 80, and the pair of end plates 50 are assembled so as to rotate integrally.

In the rotor core 30, a plurality (eight in the embodiment) of in-core flow paths 31 formed at equal intervals in the circumferential direction are formed inside the rotor core 30 for flowing the refrigerant.

On the outer peripheral surface of the rotor core 30, the magnet attaching grooves 41A described above are provided at equal intervals in the circumferential direction. Further, a partition portion 43 is provided in a portion between the magnet attaching grooves 41A adjacent in the circumferential direction, so that the outer diameter of the partition portion 43 is set to be substantially the same as the outer diameter of the magnet 41 arranged in the magnet attaching groove 41A. On both sides of the magnet attaching groove 41A, shoulder portions 44 each of which is larger than the outer diameter of the magnet attaching groove 41A and smaller than the outer diameter of the partition portion 43 are provided, so a flux barrier 34 is formed between the partition portion 43 and the side surface of the magnet 41 by the shoulder portion 44.

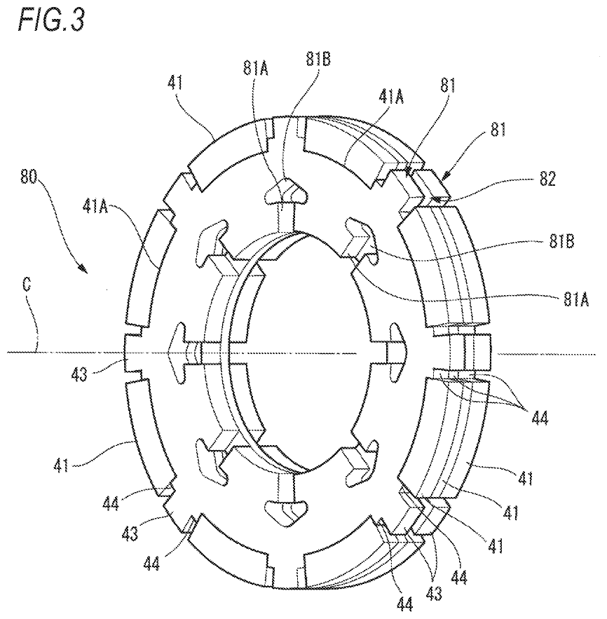

In the rotor core 30, the above-described refrigerant distribution plate 80 connecting the refrigerant supply portion of the rotor shaft 20 and the in-core flow path 31 of the rotor core 30 is interposed. As illustrated in FIG. 3, the first refrigerant distribution plate 81 and the second refrigerant distribution plate 82 are stacked in the axial direction. More specifically, the refrigerant distribution plate 80 includes a pair of first refrigerant distribution plates 81 and a second refrigerant distribution plate 82 interposed between the pair of first refrigerant distribution plates 81.

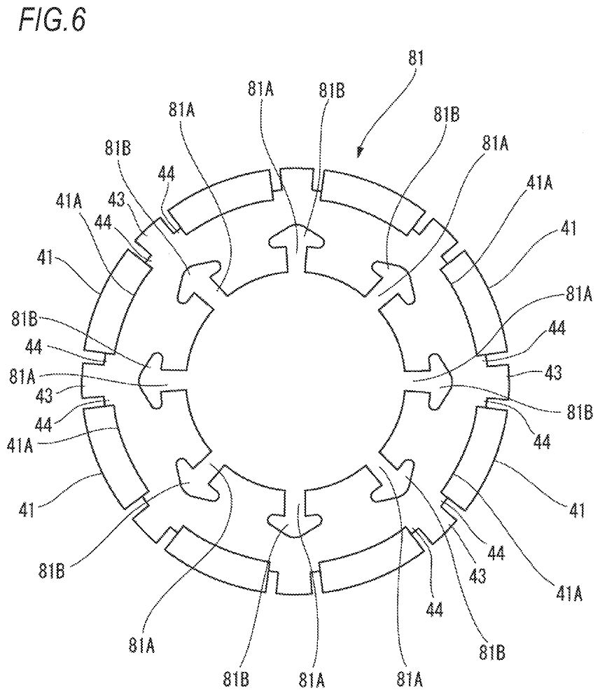

As illustrated in FIG. 6, the first refrigerant distribution plate 81 is formed with an inner-diameter-side refrigerant flow path 81A extending from the in-shaft flow path 21 to the in-core flow path 31 when viewed from the axial direction. On the outer peripheral surface of the first refrigerant distribution plate 81, a magnet attaching groove 41A, a partition portion 43, and the shoulder portion 44 are provided at the same circumferential position as the magnet attaching groove 41A of the rotor core 30.

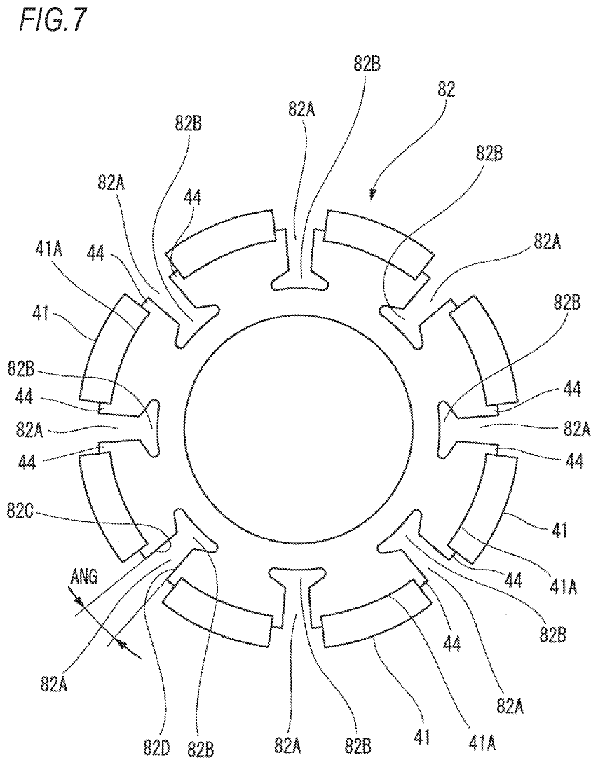

As illustrated in FIG. 7, the second refrigerant distribution plate 82 has an outer-diameter-side refrigerant flow path 82A extending from the in-core flow path 31 toward the magnet attaching groove 41A when viewed from the axial direction. On the outer peripheral surface of the second refrigerant distribution plate 82, a magnet attaching groove 41A is provided at the same position in the circumferential direction as the magnet attaching groove 41A of the rotor core 30. Further, outlet of the outer-diameter-side refrigerant flow path 82A is provided between the circumferentially adjacent magnet attaching grooves 41A with the shoulder portions 44, which provided on both sides of the magnet attaching grooves 41A, interposed therebetween. That is, the partition portion 43 is not provided in the second refrigerant distribution plate 82 and a space is formed between the outer peripheral surface (shoulder portion 44) of the second refrigerant distribution plate 82 and the sleeve 40.

According to this, since the refrigerant flowing through the in-shaft flow path 21 is supplied to the in-core flow path 31 via the inner-diameter-side refrigerant flow path 81A provided in the first refrigerant distribution plate 81, the magnet 41 can be cooled from inside the rotor core 30 by the refrigerant flowing through the in-core flow path 31. In the embodiment, by providing two first refrigerant distribution plates 81, there are a total of sixteen inner-diameter-side refrigerant flow paths 81A, eight in the circumferential direction and two in the axial direction. A part of the refrigerant passing through the inner-diameter-side refrigerant flow path 81A is supplied to an outer-diameter-side refrigerant flow path 82A provided in the second refrigerant distribution plate 82. In the embodiment, by providing one second refrigerant distribution plate 82, there are a total of eight outer-diameter-side refrigerant flow paths 82A, eight in the circumferential direction and one in the axial direction.

Here, the inner-diameter-side refrigerant flow path 81A and the outer-diameter-side refrigerant flow path 82A constitute a first refrigerant flow path 11 extending from the in-shaft flow path 21 through the in-core flow path 31 and further in the radial direction of the rotor core 30. Also, at the outlet of the outer-diameter-side refrigerant flow path 82A, a second refrigerant flow path 12 is formed by a space formed between the outer peripheral surface (shoulder portion 44) of the second refrigerant distribution plate 82 and the sleeve 40. The second refrigerant flow path 12 is connected to the first refrigerant flow path 11 and extends in the circumferential direction of the rotor core 30. The refrigerant flowing in the second refrigerant flow path 12 in the circumferential direction is supplied to the magnet attaching grooves 41A on both sides of the outer-diameter-side refrigerant flow path 82A through the space between the partition portions 43 of the pair of first refrigerant distribution plates 81 opposed in the axial direction.

Further, the space between the shoulder portions 44 provided on both sides of the magnet attaching groove 41A and the sleeve 40 constitutes a third refrigerant flow path 13. In other words, the third refrigerant flow path 13 is constituted by the flux barrier 34 and the sleeve 40. The third refrigerant flow path 13 is connected to the second refrigerant flow path 12 and extends in the axial direction along a plurality of magnets 41. Therefore, the refrigerant supplied to the outer-diameter-side refrigerant flow path 82A is supplied to the third refrigerant flow path 13 via the second refrigerant flow path 12, so that the magnet 41 can be directly cooled.

The refrigerant distribution plate 80 is preferably made of the same material as the rotor core 30 and is more preferably formed by stacking electromagnetic steel sheets. Accordingly, the refrigerant distribution plate 80 has both a function of generating torque and a function of distributing the refrigerant and can suppress a decrease in torque due to the member which distributes the refrigerant.

Further, as illustrated in FIG. 6, the first refrigerant distribution plate 81 includes a first refrigerant storage portion 81B provided so as to overlap the in-core flow path 31 in the circumferential direction of the rotor core 30. The inner-diameter-side refrigerant flow path 81A extends in the radial direction of the rotor core 30 from the in-shaft flow path 21 toward the first refrigerant storage portion 81B. As illustrated in FIG. 7, the second refrigerant distribution plate 82 includes a second refrigerant storage portion 82B provided so as to overlap the in-core flow path 31 in the circumferential direction of the rotor core 30. The outer-diameter-side refrigerant flow path 82A extends in the radial direction from the second refrigerant storage portion 82B toward the magnet attaching groove 41A. The first refrigerant storage portion 81B and the second refrigerant storage portion 82B have substantially the same shape as the in-core flow path 31 and are configured such that the radially inner side forms a triangle base and the radially outer side forms a triangle vertex when viewed from the axial direction. Each vertex of the triangles is formed in an R shape.

According to this, by the first refrigerant storage portion 81B and the second refrigerant storage portion 82B provided to overlap with the in-core flow path 31 in the circumferential direction of the rotor core 30, the refrigerant flowing from the inner-diameter-side refrigerant flow path 81A to the in-core flow path 31 and the refrigerant flowing from the inner-diameter-side refrigerant flow path 81A to the outer-diameter-side refrigerant flow path 82A can be appropriately separated.

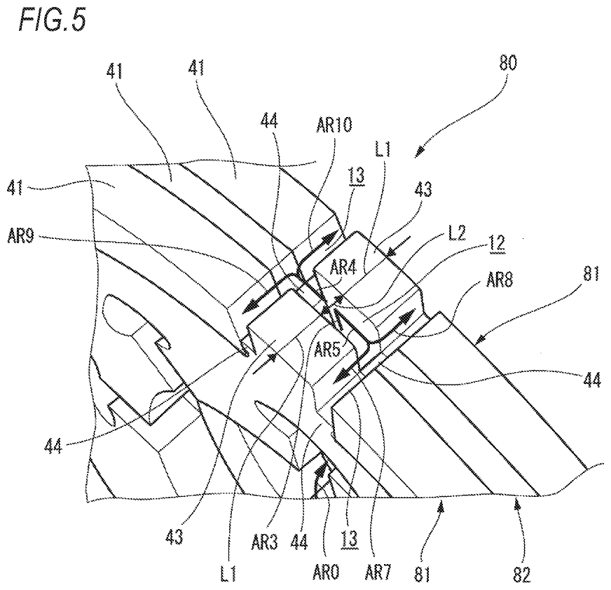

Here, as illustrated in FIG. 5, an axial width L1 of the first refrigerant distribution plate 81 is wider than an axial width L2 of the second refrigerant distribution plate 82 (L1>L2). By making the axial width L1 of the first refrigerant distribution plate 81 wider than the axial width L2 of the second refrigerant distribution plate 82, the amount of refrigerant flowing from the inner-diameter-side refrigerant flow path 81A to the outer-diameter-side refrigerant flow path 82A can be appropriately adjusted. In addition, the dimensions of the widths L1 and L2 can be appropriately changed in consideration of the relationship between the amount of the refrigerant flowing through the in-core flow path 31 and the amount of the refrigerant flowing through the outer-diameter-side refrigerant flow path 82A.

As illustrated in FIG. 2, a plurality of the in-core flow paths 31, the first refrigerant storage portions 81B, and the second refrigerant storage portions 82B are arranged at predetermined intervals in the circumferential direction. In addition, the in-core flow path 31, the first refrigerant storage portion 81B, and the second refrigerant storage portion 82B overlap at substantially the same position and substantially the same shape when viewed from the axial direction. As described above, since the in-core flow paths 31, the first refrigerant storage portions 81B, and the second refrigerant storage portions 82B are arranged at predetermined intervals in the circumferential direction, the temperature distribution of the magnets 41 in the circumferential direction can be reduced.

As illustrated in FIGS. 2 and 3, the inner-diameter-side refrigerant flow path 81A and the outer-diameter-side refrigerant flow path 82A extend in the radial direction between the magnets 41 adjacent in the circumferential direction. The inner-diameter-side refrigerant flow path 81A and the outer-diameter-side refrigerant flow path 82A extend in the radial direction between the magnets 41 adjacent in the circumferential direction, so the refrigerant can be supplied to the magnets 41 adjacent in the circumferential direction through one set of the inner-diameter-side refrigerant flow path 81A and the outer-diameter-side refrigerant flow path 82A.

Further, as illustrated in FIG. 7, the outer-diameter-side refrigerant flow path 82A has a wider circumferential width from the second refrigerant storage portion 82B to the magnet attaching groove 41A. In the embodiment, an angle ANG between a surface 82C and a surface 82D of the outer-diameter-side refrigerant flow path 82A is formed to be larger than 0°. This allows the refrigerant flowing through the outer-diameter-side refrigerant flow path 82A to flow smoothly toward the magnet attaching groove 41A.

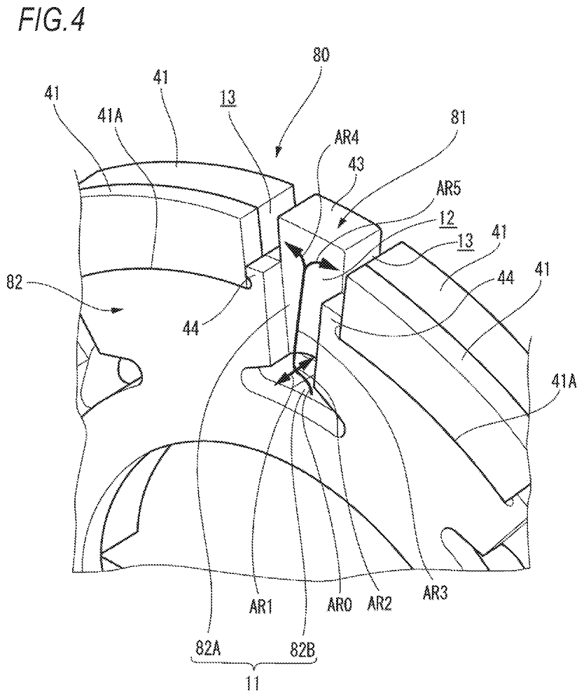

Next, the refrigerant flowing through the refrigerant distribution plate 80 will be described more specifically with reference to FIGS. 4 and 5.

The refrigerant flowing in a direction of an arrow AR0 through the inner-diameter-side refrigerant flow path 81A (first refrigerant flow path 11) of the first refrigerant distribution plate 81 temporarily stays in the first refrigerant storage portion 81B and the second refrigerant storage portion 82B and a part of the refrigerant is supplied to the in-core flow path 31 of the first rotor core 30A and the in-core flow path 31 of the second rotor core 30B as indicated by arrows AR1 and AR2.

Also, the remaining refrigerant temporarily staying in the first refrigerant storage portion 81B and the second refrigerant storage portion 82B flows through the outer-diameter-side refrigerant flow path 82A (first refrigerant flow path 11) as shown by an arrow AR3 and hits the sleeve 40 (see FIG. 1). Then, as indicated by arrows AR4 and AR5, the flow is changed to flows toward both sides in the circumferential direction and the refrigerant flows through the second refrigerant flow path 12. Next, the refrigerant hits the side surface of the magnet 41, changes the flow to flow toward both sides in the axial direction, and flows through the third refrigerant flow path 13. That is, the refrigerant flowing through the second refrigerant flow path 12 indicated by the arrow AR4 flows in the third refrigerant flow path 13 in the axial direction along the side surface of the magnet 41 as indicated by arrows AR9 and AR10. On the other hand, the refrigerant flowing through the second refrigerant flow path 12 indicated by the arrow AR5 flows in the axial direction through the third refrigerant flow path 13 along the side surface of the magnet 41 as indicated by arrows AR7 and AR8.

In addition, when a difference appears in the supply balance of the refrigerant to one magnet 41 and the other magnet 41 due to the rotation effect of the rotor 10 of the rotary electric machine, by individually setting the width (cross-sectional area of oil passage) of the shoulder portion 44 of the second refrigerant distribution plate 82 in one and the other, one and the other can arbitrarily control the supply balance of the refrigerant supplied to the third refrigerant flow path 13. For example, as illustrated in FIG. 5, when the refrigerant flowing in the directions of the arrows AR7 and AR8 is more than the refrigerant flowing in the directions of the arrows AR9 and AR10, in order to reduce the flow rate of the refrigerant flowing in the directions of the arrows AR7 and AR8, the width (cross-sectional area of oil passage) of the shoulder portion 44 of the second refrigerant distribution plate 82 in the directions of the arrows AR7 and AR8 is reduced.

In this way, by the refrigerant supplied from the inner-diameter-side refrigerant flow path 81A (first refrigerant flow path 11) to the in-core flow path 31 of the first rotor core 30A and the in-core flow path 31 of the second rotor core 30B, the magnet 41 can be cooled from inside the rotor core 30. Also, by the refrigerant supplied from the inner-diameter-side refrigerant flow path 81A and the outer-diameter-side refrigerant flow path 82A (first refrigerant flow path 11) to the third refrigerant flow path 13 via the second refrigerant flow path 12, the magnet 41 can be directly cooled. Therefore, the magnet 41 can be appropriately cooled.

Hereinbefore, the embodiment of the invention is described. However, the invention is not limited to the embodiment described above and modifications, improvements, and the like can be made as appropriate.

For example, the numbers of the first refrigerant distribution plate 81 and the second refrigerant distribution plate 82 constituting the refrigerant distribution plate 80 can be appropriately set. That is, the first refrigerant distribution plate 81 and the second refrigerant distribution plate 82 may be at least one each, and may be two or more.

In addition, at least the following matters are described in this specification. In the parentheses, components and the like corresponding to the above-described embodiment are shown, but the invention is not limited thereto.

(1) A rotor (rotor 10 of rotary electric machine) of a rotary electric machine which includes a rotor core (rotor core 30), a plurality of magnets (magnets 41) arranged on an outer peripheral surface of the rotor core, and a rotor shaft (rotor shaft 20) rotating integrally with the rotor core, where

the rotor shaft is provided with,

an in-shaft flow path (in-shaft flow path 21) through which a refrigerant is supplied,

in the rotor core,

a plurality of magnet attaching grooves (magnet attaching grooves 41A) formed on the outer peripheral surface of the rotor core and in which the magnets are disposed and an in-core flow path (in-core flow path 31) extending inside the rotor core in an axial direction of the rotor core are provided and a refrigerant distribution plate (refrigerant distribution plate 80) is interposed, and

in the refrigerant distribution plate,

a first refrigerant distribution plate (first refrigerant distribution plate 81) in which an inner-diameter-side refrigerant flow path (inner-diameter-side refrigerant flow path 81A) extending from the in-shaft flow path toward the in-core flow path as viewed from the axial direction is formed, and

a second refrigerant distribution plate (second refrigerant distribution plate 82) in which an outer-diameter-side refrigerant flow path (outer-diameter-side refrigerant flow path 82A) extending from the in-core flow path toward the magnet attaching groove as viewed from the axial direction is formed are provided, and

the first refrigerant distribution plate and the second refrigerant distribution plate are stacked in the axial direction.

According to (1), since the refrigerant flowing in the in-shaft flow path is supplied to the in-core flow path via the inner-diameter-side refrigerant flow path provided in the first refrigerant distribution plate, the magnet can be cooled from inside the rotor core by the refrigerant flowing through the in-core flow path. In addition, since a part of the refrigerant passing through the inner-diameter-side refrigerant flow path is supplied to the magnet attaching groove via the outer-diameter-side refrigerant flow path provided in the second refrigerant distribution plate, the magnet can be cooled directly by the refrigerant supplied to the magnet attaching groove.

(2) The rotor of the rotary electric machine according to (1), where

the first refrigerant distribution plate includes a first refrigerant storage portion (first refrigerant storage portion 81B) provided to overlap with the in-core flow path in a circumferential direction of the rotor core,

the inner-diameter-side refrigerant flow path extends in a radial direction of the rotor core from the in-shaft flow path toward the first refrigerant storage portion,

the second refrigerant distribution plate includes a second refrigerant storage portion (second refrigerant storage portion 82B) provided to overlap with the in-core flow path in the circumferential direction of the rotor core, and

the outer-diameter-side refrigerant flow path extends in the radial direction from the second refrigerant storage portion toward the magnet attaching groove.

According to (2), by the first refrigerant storage portion and the second refrigerant storage portion provided to overlap the in-core flow path in the circumferential direction of the rotor core, the refrigerant flowing from the inner-diameter-side refrigerant flow path to the in-core flow path and the refrigerant flowing from the inner-diameter-side refrigerant flow path to the outer-diameter-side refrigerant flow path can be appropriately separated.

(3) The rotor of the rotary electric machine according to (2), where

a plurality of the in-core flow paths, the first refrigerant storage portions, and the second refrigerant storage portions are arranged at predetermined intervals in the circumferential direction.

According to (3), since a plurality of the in-core flow paths, the first refrigerant storage portions, and the second refrigerant storage portions are arranged at the predetermined intervals in the circumferential direction, the temperature distribution of the magnet in the circumferential direction can be reduced.

(4) The rotor of the rotary electric machine according to (3), where

the inner-diameter-side refrigerant flow path and the outer-diameter-side refrigerant flow path extend in the radial direction between the magnets adjacent in the circumferential direction.

According to (4), since the inner-diameter-side refrigerant flow path and the outer-diameter-side refrigerant flow path extend in the radial direction between the magnets adjacent in the circumferential direction, the refrigerant can be supplied to the magnets adjacent in the circumferential direction through one set of the inner-diameter-side refrigerant flow path and the outer-diameter-side refrigerant flow path.

(5) The rotor of the rotary electric machine according to any one of (2) to (4), where

a circumferential width of the outer-diameter-side refrigerant flow path becomes wider from the second refrigerant storage portion toward the magnet attaching groove.

According to (5), since the circumferential width of the outer-diameter-side refrigerant flow path becomes wider from the second refrigerant storage portion toward the magnet attaching groove, the refrigerant flowing through the outer-diameter-side refrigerant flow path can flow smoothly to the magnet attaching groove.

(6) The rotor of the rotary electric machine according to any one of (1) to (5), where

an axial width of the first refrigerant distribution plate is set to be wider than an axial width of the second refrigerant distribution plate.

According to (6), by making the axial width of the first refrigerant distribution plate wider than the axial width of the second refrigerant distribution plate, the amount of refrigerant flowing from the inner-diameter-side refrigerant flow path to the outer-diameter-side refrigerant flow path can be appropriately adjusted.

(7) The rotor of the rotary electric machine according to any one of (1) to (6), where

the second refrigerant distribution plate is disposed between a pair of the first refrigerant distribution plates.

According to (7), by disposing the second refrigerant distribution plate between the pair of first refrigerant distribution plates, the first refrigerant distribution plates can be made symmetrical about the second refrigerant distribution plate in the axial direction.

(8) The rotor of the rotary electric machine according to any one of (1) to (7), where

a plurality of magnet attaching grooves (magnet attaching grooves 41A) in which magnets are arranged are provided on an outer peripheral surface of the refrigerant distribution plate, and

the magnet is arranged in the magnet attaching groove.

According to (8), by arranging the magnets also on the outer peripheral surface of the refrigerant distribution plate, the amount of magnets in the rotor can be increased, and thus the output of the rotary electric machine can be increased.

(9) The rotor of the rotary electric machine according to any one of (1) to (8), where

the rotor core includes a first rotor core (first rotor core 30A) and a second rotor core (second rotor core 30B), and

the first rotor core and the second rotor core are arranged so as to face each other across the refrigerant distribution plate in the axial direction.

According to (9), the temperature distribution of the magnet in the axial direction can be suppressed as compared with a case where the refrigerant distribution plate is arranged on one side of the first rotor core and the second rotor core.

1. A rotor of a rotary electric machine comprising:
a rotor core:
a plurality of magnets arranged on an outer peripheral surface of the rotor core; and
a rotor shaft rotating integrally with the rotor core, wherein:
the rotor shaft includes an in-shaft flow path through which a refrigerant is supplied;
the rotor core includes:
a plurality of magnet attaching grooves formed on the outer peripheral surface of the rotor core and in which the magnets are disposed;
an in-core flow path extending inside the rotor core in an axial direction of the rotor core; and
a refrigerant distribution plate;
the refrigerant distribution plate includes:
a first refrigerant distribution plate in which an inner-diameter-side refrigerant flow path extending from the in-shaft flow path toward the in-core flow path as viewed from the axial direction is formed; and
a second refrigerant distribution plate in which an outer-diameter-side refrigerant flow path extending from the in-core flow path toward the magnet attaching groove as viewed from the axial direction is formed; and
the first refrigerant distribution plate and the second refrigerant distribution plate are stacked in the axial direction.

2. The rotor of the rotary electric machine according to claim 1, wherein:
the first refrigerant distribution plate includes a first refrigerant storage portion provided to overlap with the in-core flow path in a circumferential direction of the rotor core;
the inner-diameter-side refrigerant flow path extends in a radial direction of the rotor core from the in-shaft flow path toward the first refrigerant storage portion;
the second refrigerant distribution plate includes a second refrigerant storage portion provided to overlap with the in-core flow path in the circumferential direction of the rotor core; and
the outer-diameter-side refrigerant flow path extends in the radial direction from the second refrigerant storage portion toward the magnet attaching groove.

3. The rotor of the rotary electric machine according to claim 2, wherein
a plurality of the in-core flow paths, the first refrigerant storage portions, and the second refrigerant storage portions are arranged at predetermined intervals in the circumferential direction.

4. The rotor of the rotary electric machine according to claim 3, wherein
the inner-diameter-side refrigerant flow path and the outer-diameter-side refrigerant flow path extend in the radial direction between the magnets adjacent in the circumferential direction.

5. The rotor of the rotary electric machine according to claim 2, wherein
a circumferential width of the outer-diameter-side refrigerant flow path becomes wider from the second refrigerant storage portion toward the magnet attaching groove.

6. The rotor of the rotary electric machine according to claim 1, wherein
an axial width of the first refrigerant distribution plate is set to be wider than an axial width of the second refrigerant distribution plate.

7. The rotor of the rotary electric machine according to claim 1, wherein
the second refrigerant distribution plate is disposed between a pair of the first refrigerant distribution plates.

8. The rotor of the rotary electric machine according to claim 1, wherein:
a plurality of magnet attaching grooves in which magnets are arranged are provided on an outer peripheral surface of the refrigerant distribution plate; and
the magnet is arranged in the magnet attaching groove.

9. The rotor of the rotary electric machine according to claim 1, wherein:
the rotor core includes a first rotor core and a second rotor core; and
the first rotor core and the second rotor core are arranged so as to face each other across the refrigerant distribution plate in the axial direction.
